(19) United States
(12) Patent Application Publication
(10) Pub. No.: US 2018/0052071 A1
(43) Pub. Date: Feb. 22, 2018

(54) Method and System for Determining a Fluid Leak

(71) Applicant: Engip LLC, Houston, TX (US)

(72) Inventors: Clifford L. Hilpert, Conroe, TX (US); Jeffrey Hilpert, Conroe, TX (US); Lewis Jackson Dutel, Houston, TX (US); Laura Tufts Meyer, Sealy, TX (US)

(73) Assignee: Engip LLC, Houston, TX (US)

(21) Appl. No.: 15/797,087

(22) Filed: Oct. 30, 2017

Related U.S. Application Data
(63) Continuation-in-part of application No. 14/932,727, filed on Nov. 4, 2015.
Application No. 14/932,727 is a continuation-in-part of application No. 15/151,323, filed on May 10, 2016.
Application No. 15/151,323 is a continuation-in-part of application No. 15/201,090, filed on Jul. 1, 2016.
(60) Provisional application No. 62/414,677, filed on Oct. 29, 2016.
(60) Provisional application No. 62/140,795, filed on Mar. 31, 2015.
(60) Provisional application No. 62/159,429, filed on May 11, 2015.
(60) Provisional application No. 62/191,419, filed on Jul. 12, 2015.

(51) Int. Cl. G01M 3/28; E21B 47/10

(52) U.S. Cl. CPC G01M 3/2876; E21B 33/06; E21B 47/1025; G01M 3/2807

(57) ABSTRACT

A method and apparatus for testing closed hydraulic systems such as a blowout preventer or wellbore and portions thereof for leaks by maintaining a constant pressure in the portion of the closed hydraulic system to be tested and imposing a pressure wave upon the constant pressure. A variable displacement pump is connected to the system for maintaining a constant pressure within the system and imposing a pressure wave upon the constant pressure. Any amount of fluid introduced into or removed from the blowout preventer in order to maintain constant pressure is measured and is an indication of the leak rate in the closed hydraulic system.

### CROSS-REFERENCE TO RELATED APPLICATIONS

This application claims priority to U.S. provisional application Ser. No. 62/414,677, filed Oct. 29, 2016 and is a continuation in part of U.S. application Ser. No. 14/932,727 filed Nov. 4, 2015 which claims priority to provisional patent application 62/140,795 filed Mar. 31, 2015. This application is also a continuation in part of U.S. application Ser. No. 15/151,323 filed May 10, 2016 which claims priority to provisional application 62/159,429 filed May 11, 2015. This application is also a continuation in part of U.S. application Ser. No. 15/201,090 filed Jul. 1, 2016 which claims priority to provisional application 62/191,419 filed Jul. 12, 2015. The entire contents of the above identified provisional and non-provisional U.S. patent applications are hereby expressly incorporated herein by reference thereto.

### BACKGROUND OF THE INVENTION

### Field of the Invention

This application is directed to a method of testing a closed hydraulic system for example a blowout preventer (BOP) assembly for fluid leaks. The Oil and Gas Exploration risk management includes the ability to control subsurface pressures which may be encounted during drilling operation. The primary mechanism utilized by operators to control downhole pressures is the hydrostatic pressure as a result of the drilling fluid contained within the wellbore. The drilling fluid is engineered and formulated to a density that provides a hydrostatic pressure inside of the wellbore that is greater than the formation pressure being drilled. In the majority of drilling operations, the hydrostatic control of wellbore pressure is adequate. However, from time-to-time the operator may encounter a higher than expected formation pressure where there is not adequate hydrostatic pressure to control the wellbore pressure. During these times the operator relies on a series of mechanical controls to stabilize the wellbore and prevent a “Blow Out”. A blow out is the uncontrolled release of fluid or gas from the wellbore. This event is extremely dangerous and therefore must be avoided if at all possible. The primary mechanical control device utilized by operators to control wellbore pressure is the Blowout Preventer (BOP) assembly. The BOP assembly consists of multiple sealing and shearing devices that are hydraulically actuated to provide various means of sealing around the drill string or shearing it off entirely, completely sealing the wellbore. It is essential that the BOP assembly operate as designed during these critical operations. Therefore it is a regulatory requirement to test the functionality and the integrity of the BOP assembly before starting drilling operations, at specific time intervals and or at specific events during the drilling operations.

### Description of Related Arts Invention

The BOP assembly test is a series of pressure tests at a minimum of two pressure levels, low pressure and high pressure. During the pressure test, fluid from an intensification pump is introduced into the closed BOP assembly in a volume sufficient to cause the internal pressure within the closed BOP assembly to rise to the first pressure test level. Once the first pressure test level is established the high pressure pump system is isolated from the closed BOP assembly and the pressure is monitored for a specified time period. This is commonly referred to in the industry as the validation phase. During the validation phase the pressure decay of the intensified intensification fluid is determined and compared to the pressure decay specification. A typical specification for compliance allows for a pressure decay rate of no more than 5 psi/minute or 25 psi total over the entirety of the five-minute test.

The validation phase compromises two distinctly different steps. The initial step of the validation phase immediately follows the pressurization phase of the hydrostatic test and precedes the actual pressure decay test step of the validation phase. During this first step of the validation phase the internal pressure of the blowout preventer is allowed, over a period of time, to stabilize. This is known within the industry as “waiting on a flat line” and can take as much as 2 hours in extreme cases. Thermal and mechanical changes caused by the pressurization phase of the hydrostatic test can result in large pressure changes immediately following the pressurization phase. The stabilization step is required to allow thermal and mechanical changes caused by the pressurization to subside so as to not influence the pressure decay test step of the validation phase.

FIG. 1 depicts a graph representative of a typical 250 psi low pressure hydrostatic test. The period between point 1 and point 2 is the pressurization phase. The period between point 2 and point 3 is the first step of the validation phase often referred to as “waiting on a flat line”. The period between point 3 and point 4 is the second step of the validation phase. The period between point 4 and point 5 is the dump phase where pressure is released to complete the hydrostatic test process. Again referring to FIG. 1, the pressurization phase takes approximately 1 minute. The first step of the validation phase takes approximately 20 minutes, but can be longer or shorter, and the second step of the validation phase takes approximately 5 minutes. The time to complete the dump phase is minimal and typically accomplished in less than 1 minute. The total test time is approximately 27 minutes. Utilizing current technology the validation phase is approximately 90% of the total test time. In addition current pressure decay technology is an inherently inaccurate, indirect indication of leak rate. It would be much more desirable to utilize a new and unique test method where a substantial portion of the validation phase was eliminated and a means of directly measuring the leak rate was provided for. Thus there remains a need for a hydrostatic test method that mitigates the thermal and mechanical effects immediate subsequent to the pressurization phase and provides a means for direct measurement of the leak rate.

### BRIEF SUMMARY OF SOME OF THE PREFERRED EMBODIMENTS

The improved hydrostatic test method of the current invention utilizes a means of maintaining a constant pressure at the specified test pressure while imposing a cyclic pressure wave this is equally divergent from the held constant specified test pressure immediately subsequent to the pressurization phase. Additionally and optionally, the rate of pressurization during the portion of the pressurization phase immediately preceding the validation phase is controlled and optimized to mitigate the undesirable effects of temperature and mechanical changes. Immediately subsequent to reaching the target pressure the pressure is held constant while a cyclic pressure wave is created that is equally divergent from the held constant test pressure both positively and negatively relative at an approximately constant rate of pressure change for approximately 1 to 5 minutes by adding or subtracting intensification fluid as needed to maintain the constant test pressure with the equally divergent cyclic pressure wave. The volume change required to maintain the constant test pressure with an imposed cyclic pressure wave equally divergent from the held constant test pressure is equal to the change in volume of the intensified fluid within the pressure vessel of the hydrostatic pressure test. The volume, corrected for thermal related volume changes, over time will yield a leak rate. Additional factors and calculation can be applied to the yielded leak rate to normalize pressure and compressibility variables.

### BRIEF DESCRIPTION OF THE DRAWINGS

For a detailed description of the preferred embodiments of the invention, reference will now be made to the accompanying drawings in which:

FIG. 1 is a graph showing the pressure time cycle of the prior art testing method.

FIG. 2 is a graph showing the pressure time cycle of the testing method accordingly to an embodiment of the invention.

FIG. 3 is a graph showing the displacement time cycle of the cyclic pressure wave for the testing method accordingly to an embodiment of the invention.

FIG. 4 is a graph showing the displacement time cycle of a pressure wave of the cyclic pressure wave of the testing method accordingly to an embodiment of the invention.

FIG. 5 is a schematic view of an embodiment of an apparatus for carrying out an embodiment of the invention.

### DETAILED DESCRIPTION OF THE PREFERRED EMBODIMENTS

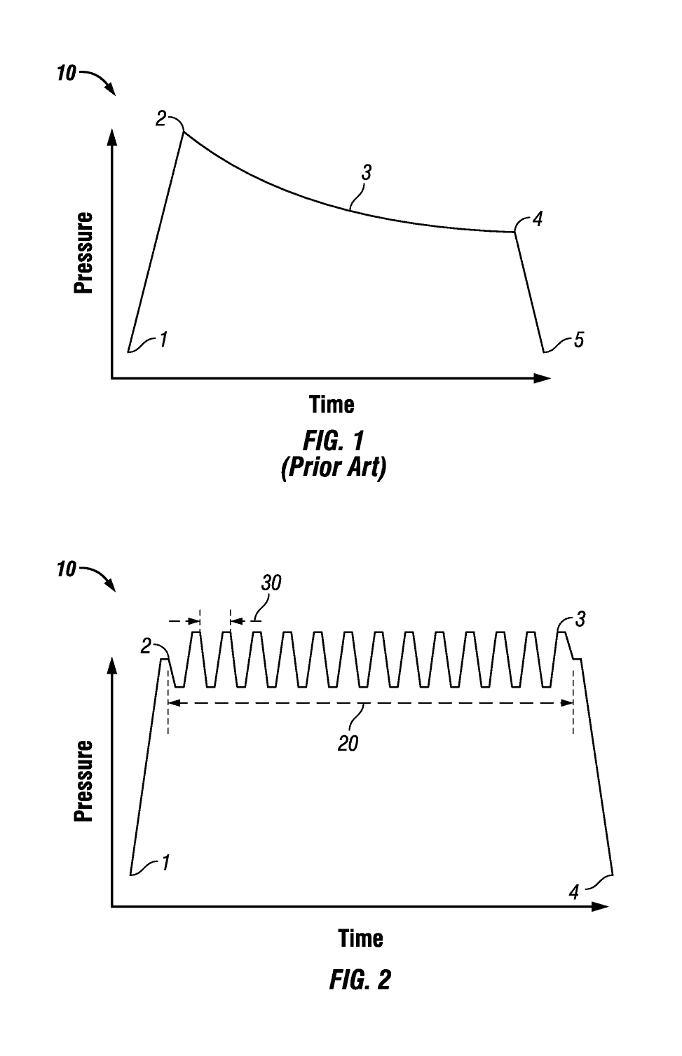

Now referring to graph 10 of FIG. 2 depicting a representative of the new and unique hydrostatic testing method. As depicted in graph 10 of FIG. 2 the period between line 1 and line 2 is the initial component of the pressurization phase. The period between line 2 and line 3 is the validation phase. The period between line 3 and line 4 is the dump phase. The period of time line 30 is representative of the time in seconds to complete one wave. The period of time line 20 is representative of the time in seconds to complete the entire cyclic wave series.

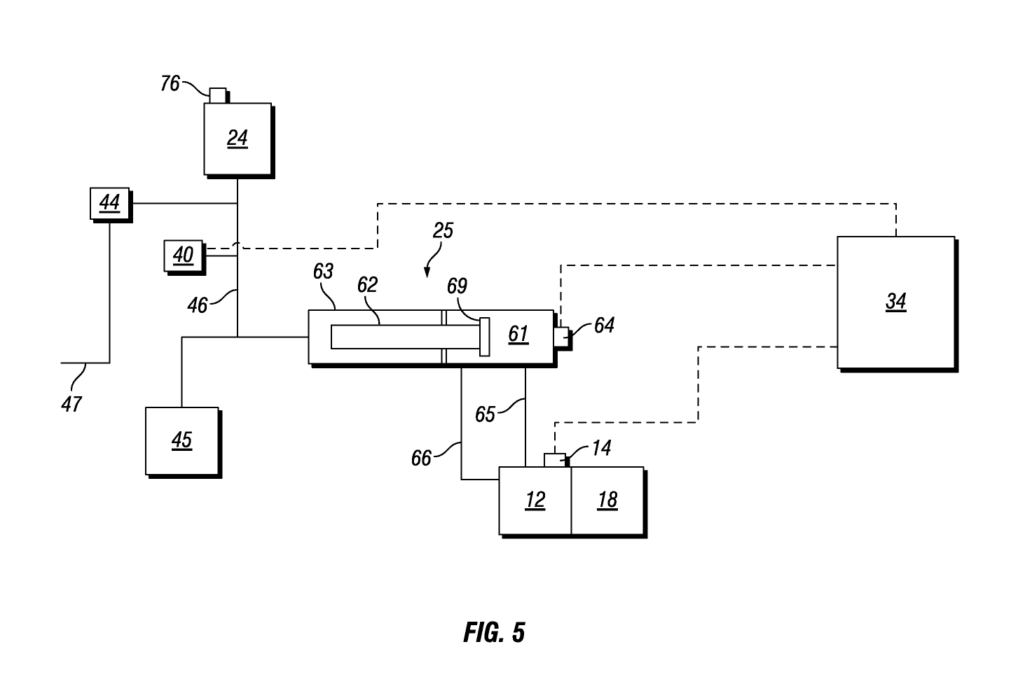

Now referring to FIG. 4 depicting the displacement volume of plunger 26 of FIG. 5 during the verification phase. The slope of polyline array 20 is representative of change in the displacement volume of plunger 26 of FIG. 5. Polyline array 20 is a polyline where each segment of the polyline is representative of the change of displacement volume of each pressure wave.

Now referring to graph 10 of FIG. 2 depicting a representative of the new and unique hydrostatic testing method. The time consumed by the initial component of the pressurization phase is variable and dependent on many factors but typically takes less than 10 minutes. The verification phase takes approximately 1 to 5 minutes. The time to complete the dump phase is minimal and typically accomplished in less than 1 minute.

In this embodiment, as depicted in FIG. 5, an intensifying cylinder 26 which is of a well-known design includes a plunger 62 located in a hydrostatic chamber 63. A piston 69 is attached to the plunger 62 and is positioned within hydraulic chamber 61 that includes precision position sensor 64. Precision position sensor 64 is scaled by controller 34 to record in engineering units of cubic centimeters (cc).

A variable displacement hydraulic pump 12 which is driven by a prime motive source such as an electric motor 18 drives intensifier plunger 26 via hydraulic lines 66 and 65 which are connected to the hydraulic power chamber 61 on either side of piston 69.

Variable displacement pump 12 may be of the type having a variable swash plate the position of which is controlled by a valve 14 in a manner known in the art.

Pressure sensor 40 is in fluid communication with fluid conduit 46.

Intensified intensification fluid within hydrostatic chamber 61 is displaced into or received from blowout preventer 24 via fluid conduit 46. The displacing of intensification fluid from within hydrostatic chamber 63 is effected by an extension of plunger 62 and is referred to as the displacing cycle. The receiving of intensification fluid to within hydrostatic chamber 63 is effected by a retraction of plunger 62 and is referred to as the receiving cycle.

This embodiment as depicted in FIG. 5 utilizes a single cylinder for displacing or receiving the intensified intensification fluid from pressure vessel 24. However, a plurality of cylinders may also be used during the test to measure the addition of any fluid necessary to maintain a constant test pressure and the imposed cyclic pressure wave that is equally divergent from the held constant test pressure within the portion of pressure vessel 24.

The pressure wave is generated by cyclically adding or subtracting, to the base pressure signal, a small pressure signal that causes a corresponding cyclic wave in the intensification fluid. For example: If the test pressure is 5,000 psi and the cyclic wave is 25 psi then the controller would send a signal to the pressure controller that further controls the hydraulic pressure that furthers controls the intensification pressure that was the sum of the base test pressure (5,000 psi) and the cyclic adder or subtractor (25 psi). If there is no leak then the cylinder will just cyclically extend and retract to cause the 25 psi wave. If there is a leak, the cylinder will cyclically extend and retract (to cause the 25 psi) but the retraction will be less than the extension causing the cylinder to extend as necessary to maintain the base test pressure (5,000 psi).

During the test, controller 34 as shown in FIG. 5 will send a signal to valve 14 to increase or decrease the pressure from variable displacement pump 12 as necessary to maintain a constant test pressure and the imposed cyclic pressure wave equally divergent from the held constant test pressure. This will cause piston 69 of intensifier cylinder 63 to move a finite distance which corresponds to the amount of intensified intensification fluid required to maintain a constant test pressure with an imposed cyclic pressure wave equally divergent from the held constant test pressure within pressure vessel 24. During this validation phase controller 34 receives time stamped signals from position sensor 64 and pressure sensor 40.

An embodiment a constant pressure test with an imposed cyclic pressure wave equally divergent from the held constant test pressure of the test method is shown in FIG. 2.

Now referring to FIG. 2. The test method according to an embodiment of the invention includes a means of providing intensification fluid utilizing a suitable intensification pump, such as the cement pump installed on most offshore drilling rigs in a volume sufficient to cause the initial pressurization of a pressure vessel such as a blowout preventer. This first phase, the pressurization phase, is identified as the period between points 1 and 2. The method of pressurization includes a means for monitoring and controlling the rate of pressurization. The rate of pressurization optionally is optimized during the initial component of the pressurization phase to initially provide the highest possible rate of pressurization within the design limitations of the intensification apparatus that mitigates the effects of thermal and mechanical induced pressure changes. The validation phase immediately following the pressurization phase of the improved hydrostatic test method comprises a period of approximately 1 to 5 minutes, but can be more or less depending on the thermal and mechanical attributes of the test vessel thereby influencing the time required to properly evaluate the volume change of the intensified intensification fluid within the pressure vessel. This period is identified as the period between points 2 and 3. The validation phase begins subsequent to the pressurization phase at or near the target test pressure. Subsequent to the validation phase the intensification pressure is bled to ambient during the dump phase. The dump phase is identified as the period between points 3 and 4. A detailed description of a single wave formed by the displacing cycle and receiving cycle of intensification cylinder 26 of FIG. 4 representative of and forming a cyclic pressure wave equally divergent from the held constant test pressure doing the monitor phase follows:

A detailed view of the displacing and receiving cycles of an embodiment of a cyclic pressure wave equally divergent from the held constant test pressure of the test method is shown in FIG. 4.

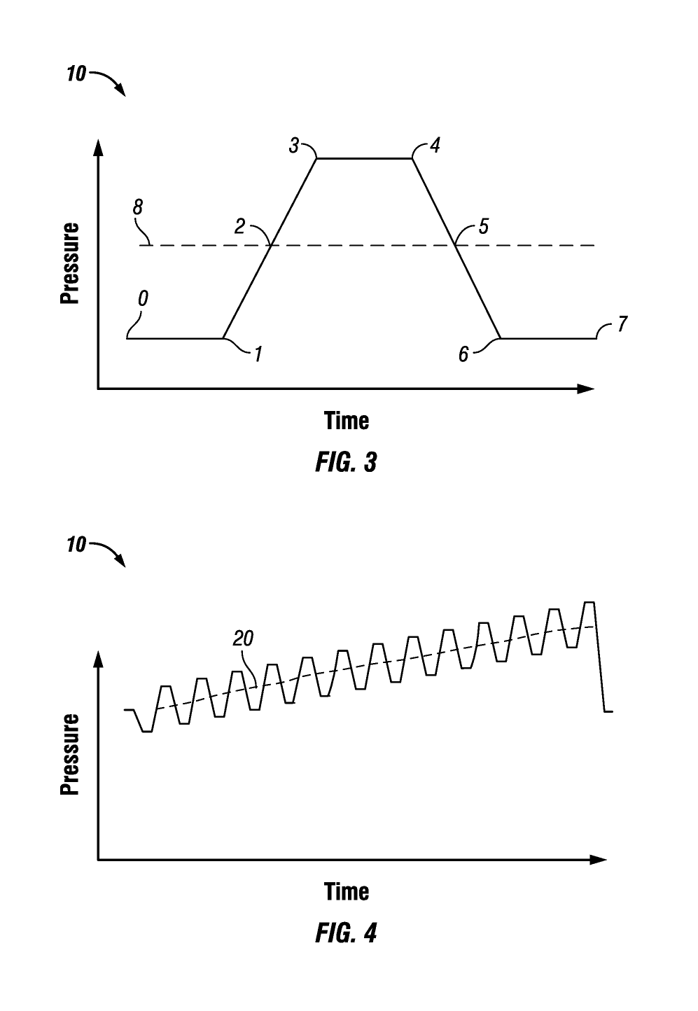

Now referring to FIG. 3 the first receiving period of an embodiment of a cyclic pressure wave begins at or near the target pressure of the hydrostatic test identified as point 0 and is a transition period from the pressurization phase to the validation phase. Subsequent to the transition period is the first wave which begins at point 1 and ends at point 6. The first wave and each subsequent wave includes 4 distinct periods, the displacing period, the receiving period, the upper transition period, and the lower transition period. The displacing period is defined as the period between points 1 and 3. The upper transition period is defined as the period between points 3 and 4. The receiving period is defined as the points between points 5 and 6. The lower transition period is defined as the period between points 6 and 7. These 4 distinct periods form a complete wave which is repeated several times imposed on the held constant test pressure to form the validation period.

As just disclosed above the period between points 1 and 2 is the displacing period and is representative of the measured change of displacement volume of plunger 62 of FIG. 5 while effecting the pressure increase of the pressure wave. Point 2 of the displacing period is representative of the displacement volume at the point where the hydrostatic pressure of the intensification fluid is equal to the held constant test pressure. As also disclosed above the period between points 4 and 5 is the receiving period and is representative of the measured change in displacement volume of plumber 62 of FIG. 5 while effecting the pressure decrease of the pressure wave. Point 5 of the receiving period is representative of the displacement volume at the point where the hydrostatic pressure of the intensification fluid is equal to the held constant test pressure. Additionally, the hydrostatic pressure of the intensification fluid at points 1, 3, 4, and 6 is recorded. All the preceding process signals are received and analyzed by controller 34 of FIG. 5.

The slope of a line drawn between points 2 and point 5, is representative of the increase or decrease in displacement volume of plunger 62 of FIG. 5 and therefore representative of the combined change in intensification fluid volume as a result of both the change of specific volume within and actual volume loss from the test vessel for the elapsed time period between point 2 and point 5. This slope is normalized to a standard period of time for comparison to subsequent wave measurements of the cyclic pressure wave.

For example; if the first wave of the cyclic pressure wave normalized recorded period of time between point 2 and point 5 is equal to 5 seconds and point 2 has a recorded displacement volume of 300 cc and point 5 has a recorded displacement volume of 352.65 cc, the resultant slope is (300−352.65)/5=10.53. This same calculation is performed for each of the slope segments of polyline 20 of FIG. 2.

An additional and important calculation can be made and is with respect to the apparent compressibility of the intensification fluid. The apparent (measured) compressibility of the intensification fluid is the result of the compressive strain of the intensification fluid and the volume of intensified intensification fluid within the test vessel. A method of determining apparent compressibility is taught in U.S. application Ser. No. 15/201,090 filed Jul. 1, 2016, the entire contents of which is expressly incorporated herein by reference thereto.

For example as taught within U.S. application Ser. No. 151201,090; if the pressure difference between point 1 and point 3 is 25 psi and the displacement volume at point 1 is 100 cc and at point 3 it is 703.5 cc the resultant apparent compressibility of the intensified intensification fluid is (703.5−100) I 25=24.14. Therefor the apparent compressibility express in cubic centimeters I pound square inch is 24.14 cc/psi. Meaning that each incremental increase of 1 psi requires 24.14 cc of additional intensification fluid. This calculation is performed with each cycle between points 1 and 3 and points 4 and 6 of each wave in the cyclic wave pattern.

Utilizing the above calculations, it is subsequently possible to determine the contributing amount of each the specific volume change related to thermal changes and the volume change related to the loss of intensification fluid via an actual leak. The is possible because the thermal related changes are constant with respect to the temperature delta which is decreasing over time and the leak rate remains constant over time. This further means if the standard deviation of an array of the results of the difference between each successive slope value in the polyline array is greater than zero there is a thermal component included in the polyline array of the slope values.

For example; a typical hydrostatic test utilizing an embodiment of this invention where time line 20 of FIG. 2 is equal to 120 seconds and where time line 30 of FIG. 2 is equal to 5 seconds would include a polyline array of the 24 slope values. Slope values that are relative constant when compared, beginning with the slope of the first wave as compared to the slope of the second wave then the slope of the second wave as compared to the slope of the third wave and continuing with this pattern of comparison unit all 24 slope values are compared, and remain approximately equal indicate the effects of thermal related specific gravity changes are neglectable. However, if the slope valves are changing as to become not equal then the effects of thermal related specific gravity changes are significant enough for consideration.

Referencing the immediately preceding example where the comparison of the slope values depicts a continuous increasing or decreasing trend are indicative of thermal related specific gravity changes within the polyline array. In these cases, the thermal related specific gravity changes can be isolated by creating an array of results by dividing the slope of the second wave by the slope of the first wave and then dividing the slope of the third wave by the slope of the second wave and continuing with this pattern of comparison unit all 24 slope values are compared. Now calculate the standard deviation of the results array. If the standard deviation of the results array is greater than 1.0E-8 then subtract a leak rate factor of 1.0E-4 from each of the 24 slope valves of the slope polyline array. Now reevaluate the standard deviation of the results array. If the standard deviation of the results array is greater than 1.0E-8 (the residual) then via iteration continue to apply the leak rate factor to the slope values of the slope polyline array as just described. The calculated leak rate slope component of the measured slope polyline will be accurate within the requirements of the test when the standard deviation of the results array is less than 1.0E-8. The leak rate factor and the residual are exemplification and may be different from test to test.

For example, and continuing to use the examples above. A typical polyline slope array might include the following array indexes 1) 10.5298, 2) 10.4872, 3) 10.4483, 4) 10.4026, 5) 10.3607, 6) 10.3190, 7) 10.2774, 8) 10.2361, 9) 10.1950, 10) 10.1541, 11) 10.1134, 12) 10.0728, 13) 10.0325, 14) 9.9924, 15) 9.9525, 16) 9.9128, 17) 9.8733, 18) 9.8340, 19) 9.7949, 20) 9.7560, 21) 9.7173, 22) 9.6787, 23) 9.6404, 24) 9.6022. The standard deviation of a results array derived from the example slope polyline array as described above is 2.716E-05. Appling, via iteration as just described above, a leak factor to each index of the results array will yield a calculated leak rate slope of 2.007. Therefore, the leak rate is 2.007*5*12=120.42 cc/min.

A more common and generally accepted unit of measure to express leak rate is pounds square inch I minute or psi/min. As previously disclosed above the apparent compressibility factor in the herein example is 24.14 cc/psi. Therefore, the leak rate express in units of psi/min is 120.42/24.14=4.98 psi/min.

It is well known within the industry that the raw signals of pressure and displacement from pressure sensor 40 and position sensor 64 of FIG. 5 may need to be filtered or conditioned to provide a more stable signal for use in making the calculations herein.

It is evident that applying this new and unique method and system and system can provide for substantial savings. In the above example the actual leak rate is calculated to be 4.98 psi/min which is a typically accepted level within the industry. The new and improved method and system only required 2 minutes to resolve the actual leak rate. Utilizing traditional hydrostatic testing technology would require more than 80 minutes for the temperature to become insignificant enough to allow for a passing test.

In another related application, hydrostatic testing of all or a portion of a wellbore below the BOP assembly is conducted to insure the pressure integrity of the wellbore. These tests can include the setting of one or more permanent or retrievable plug(s) to isolate a portion of the wellbore to be tested or may include the wellbore below the BOP assembly in its entirety. During these tests, very much the same as previously described, intensification fluid is intensified with the portion of the wellbore to be tested via intensification pump 26 of FIG. 5. As previously described thermal changes to the specific gravity of the intensifying fluid can cause extreme delays where pressure or volume of the intensified fluid is utilized as indicators of a leak. During these tests, it would be much more desirable to utilize a new and unique test method where a substantial portion of the validation phase was eliminated and a means of directly measuring the leak rate was provided for.

Providing a means of detecting leaks immediately subsequent to the pressure phase negates the requirement for a pressure decay validation phase thereby saving substantial time and money.

Although the present invention and its advantages have been described in detail, it should be understood that various changes, substitutions and alterations may be made herein without departing from the spirit and scope of the invention as defined by the appended claims.

What is claimed is:

1. A method of testing for leaks in a closed hydraulic system comprising:
a. pressurizing the portion of the closed hydraulic system to a first pressure level,
b. maintaining a constant pressure within the portion of the closed hydraulic system to be tested,
c. imposing a pressure wave upon the held constant pressure within the portion of the closed hydraulic system to be tested,
d. measuring any amount of fluid added to or removed from the pressurized portion of the closed hydraulic system that is required to maintain the pressure within the portion to be tested at a constant level.

2. The method as claimed in claim 1 wherein the pressure is maintained constant by a. intensifier pump driven by a variable displacement hydraulic pump.

3. The method as claimed in claim 1 wherein the intensifier pump includes an axially movable piston and the amount of fluid added to or removed from the portion of the portion of the closed hydraulic system is measured by measuring any displacement of the piston after the portion of the closed hydraulic system to be tested has been pressurized to the first pressure level.

4. The method as claimed in claim 1 further including the step of determining the amount of fluid required to be added to or removed from the portion of the closed hydraulic system to generate a pressure increase or decrease of one psi.

5. The method of claim 1 wherein the portion of the closed hydraulic system is a blowout preventer for an oil/gas well.

6. The method of claim 1 wherein the portion of the closed hydraulic system is a wellbore of an oil/gas well.

7. The method of claim 1 wherein the pressure wave is equally divergent from the first pressure level.
